(19) United States
(12) Patent Application Publication
(10) Pub. No.: US 2008/0263550 A1
(43) Pub. Date: Oct. 23, 2008

(54) A SYSTEM AND METHOD FOR SCHEDULED DISTRIBUTION OF UPDATED DOCUMENTS

(76) Inventors: William Su, Riverside, CA (US); Hongfeng Wei, Anaheim, CA (US); Jianxin Wang, Trabuco Canyon, CA (US); Mohammad Suleiman, Trabuco Canyon, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/736,951

(22) Filed: Apr. 18, 2007

(51) Int. Cl. G06F 9/46; G06F 17/30

(52) U.S. Cl. 718/102; 707/1; 707/E17.008

(57) ABSTRACT

The subject application is directed to a system and method for scheduled distribution of updated documents. Document data corresponding to at least one electronic document associated with a meeting is first stored in an associated data storage. Next, identification data representing each invitee to the meeting is stored in the storage. Event data corresponding to the scheduled timing of the meeting event is then stored in the associated data storage. Document processing operation data, corresponding to one or more document processing operations to be performed on the received document data, is also stored in the associated data storage. The stored document data is then retrieved from the data storage at an appointed time in accordance with the stored event data. At least one of the associated document processing operations is then commenced on the retrieved document data based upon the stored document processing operation data.

### BACKGROUND OF THE INVENTION

The subject application is directed generally to scheduled distribution of documents, such as to meeting attendees, in advance of a scheduled meeting. It will be appreciated that the application is particularly advantageous in assuring that documents are distributed in advance of meetings, and in a form that includes the most recent modifications or updates.

Meetings are an essential aspect of operating a business. Most meetings require the assembly and distribution of documentation in advance of the meetings or for distribution at an outset or during a meeting. Such documents may include photocopies or printouts of scanned documents, word processing files, or the like. Paper distribution may be advantageous for in-person attendees. However, many modern day meetings are completed, in whole or in part, electronically and at one or more locations.

Some attendees prefer hard copies of documents, while some may want electronic copies instead of or in addition to hard copies. Remote attendees may require remote printing or transmission, such as by electronic mail transmission or FTP transmission of electronic documents.

There is a substantial amount of effort that must be made to assure that all meeting attendees have the proper documentation in the desired format. Additionally, much of such documentation evolves, often being updated or modified to a point just prior to the meeting. Changes, such as last minute changes, information, such as current stock prices or market conditions, or recent current events of interest, may not be reflected in documentation assembled for meetings, even though the success of the meeting may be impacted by less current information.

### SUMMARY OF THE INVENTION

In accordance with one embodiment of the subject application, there is provided a system and method for scheduled distribution of updated documents.

Further, in accordance with one embodiment of the subject application, there is provided a system and method for scheduled distribution of documents, such as to meeting attendees, in advance of a scheduled meeting.

Still further, in accordance with one embodiment of the subject application, there is provided a system and method for assuring that documents are distributed in advance of meetings, and in a form that includes the most recent modifications or updates.

Further, in accordance with one embodiment of the subject application, there is provided a system for scheduled distribution of updated documents. The system includes a data storage having means adapted for storing document data representative of at least one electronic document associated with a meeting event and means adapted for storing identification data representative of each of a plurality invitees to the meeting event. The data storage also includes means adapted for storing event data representative of a scheduled timing of the meeting event and means adapted for storing document processing operation data representative of at least one document processing operation. The system also includes retrieval means adapted for retrieving stored document data from the data storage in accordance with the event data and document processing means adapted for commencing at least one document processing operation on retrieved document data in accordance with the document processing operation data.

In one embodiment of the subject application, the at least one document processing operation is from a set comprising a print operation, electronic mail operation, and facsimile transmission.

In another embodiment of the subject application, the retrieval means includes means adapted for retrieving stored document data at a preselected timing prior to the meeting event. Preferably, the system further comprises means adapted for receiving data representative of the preselected timing from an associated user.

In yet another embodiment of the subject application, the system further comprises detection means adapted for detecting modification to stored electronic document data. In such embodiment, the document processing means includes means adapted for commencing at least one document processing operation on retrieved document data in accordance with an output of the detection means.

In a further embodiment of the subject application, the system further comprises means adapted for displaying data representative of a timing of the at least one document processing operation.

Still further, in accordance with one embodiment of the subject application, there is provided a method for scheduled distribution of updated documents in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for scheduled distribution of updated documents according to one embodiment of the subject application;

FIG. 2 is a block diagram illustrating device hardware for use in the system for scheduled distribution of updated documents according to one embodiment of the subject application;

FIG. 3 is a functional diagram illustrating the device for use in the system for scheduled distribution of updated documents according to one embodiment of the subject application;

FIG. 4 is a block diagram illustrating controller hardware for use in the system for scheduled distribution of updated documents according to one embodiment of the subject application;

FIG. 5 is a functional diagram illustrating the controller for use in the system for scheduled distribution of updated documents according to one embodiment of the subject application;

FIG. 6 is a flowchart illustrating a method for scheduled distribution of updated documents according to one embodiment of the subject application; and

FIG. 7 is a flowchart illustrating a method for scheduled distribution of updated documents according to one embodiment of the subject application.

### DETAILED DESCRIPTION OF THE PREFERRED EMBODIMENT

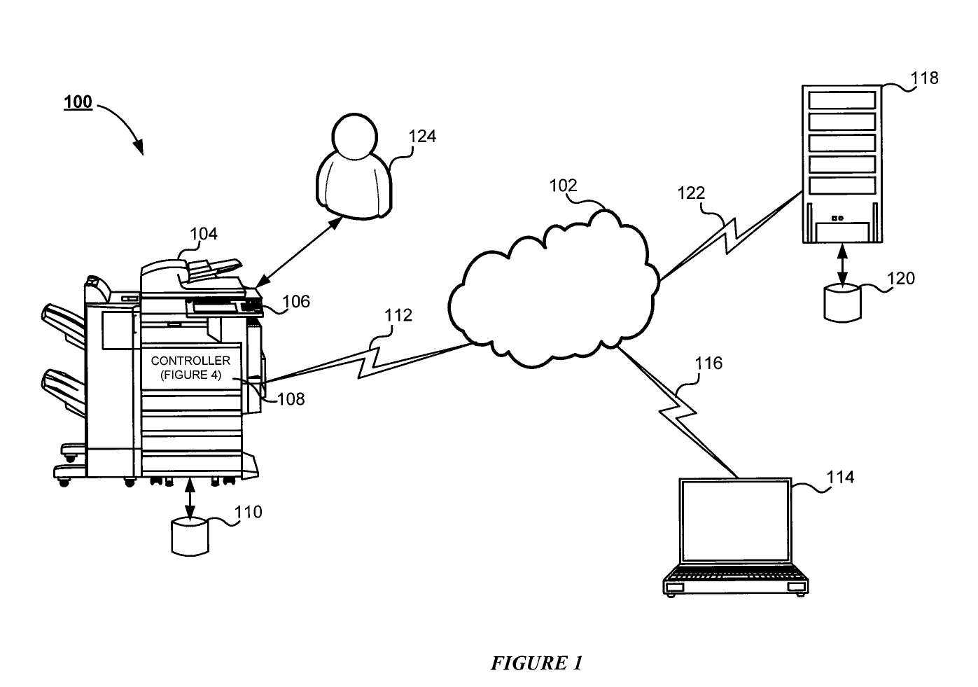

The subject application is directed to a system and method for scheduled distribution of updated documents. In particular, the subject application is directed to a system and method for scheduled distribution of documents, such as to meeting attendees, in advance of a scheduled meeting. More particularly, the subject application is directed to a system and method for assuring that documents are distributed in advance of meetings, and in a form that includes the most recent modifications or updates. It will become apparent to those skilled in the art that the system and method described herein are suitably adapted to a plurality of varying electronic fields employing updating procedures, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for scheduled distribution of updated documents in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

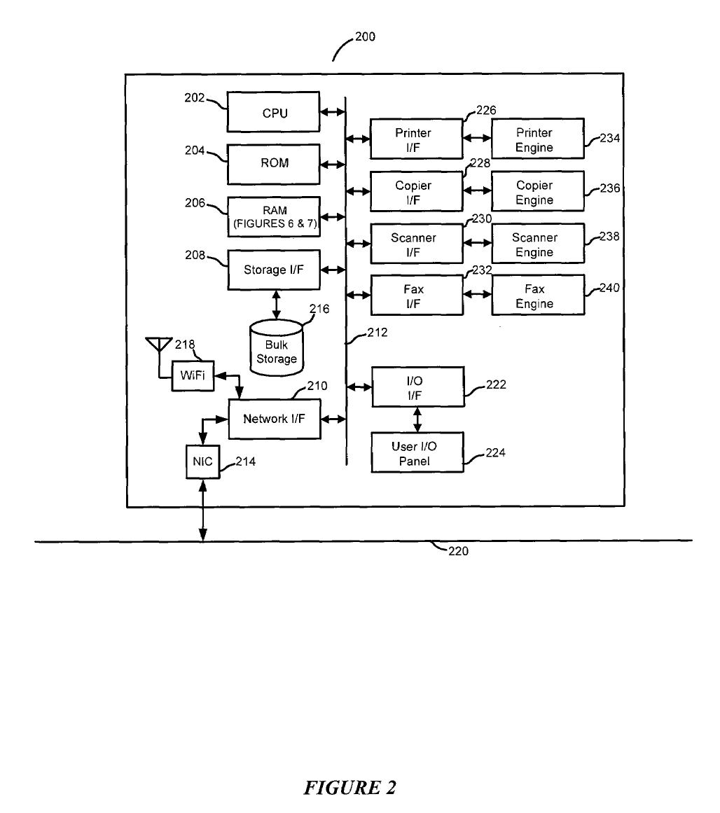

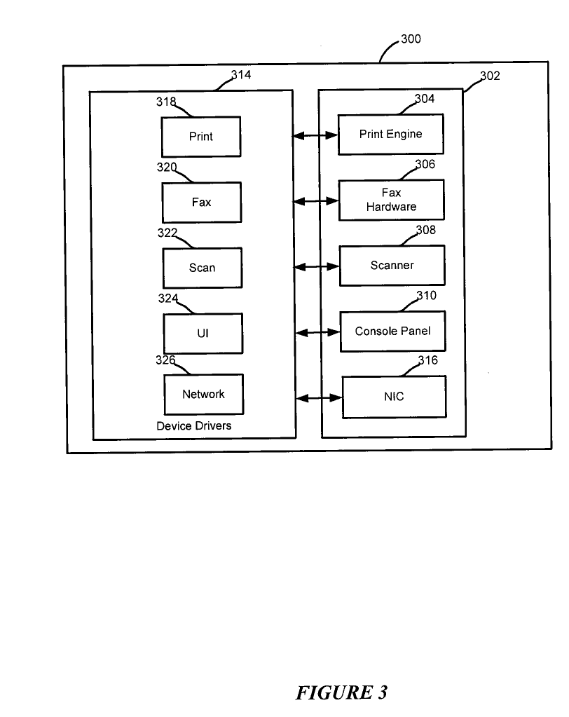

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

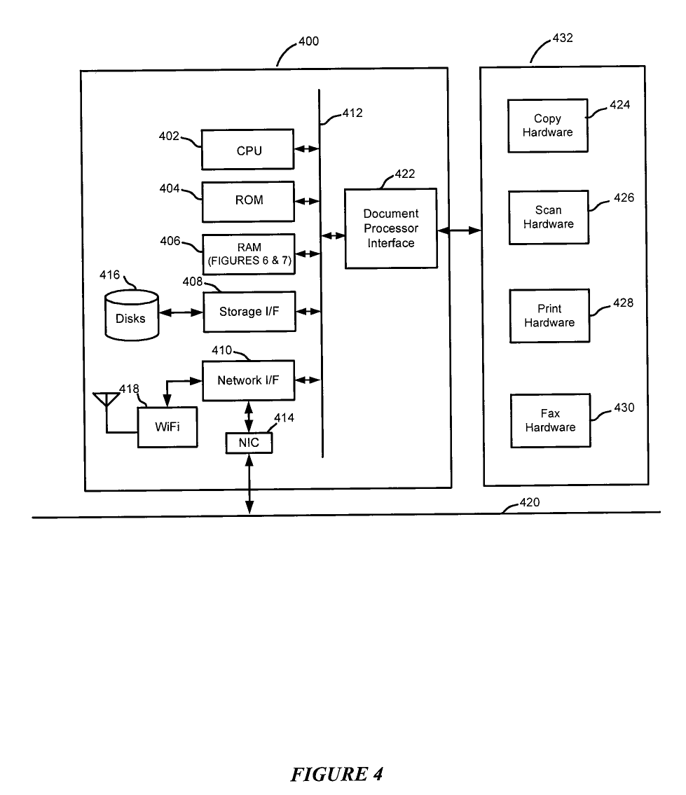

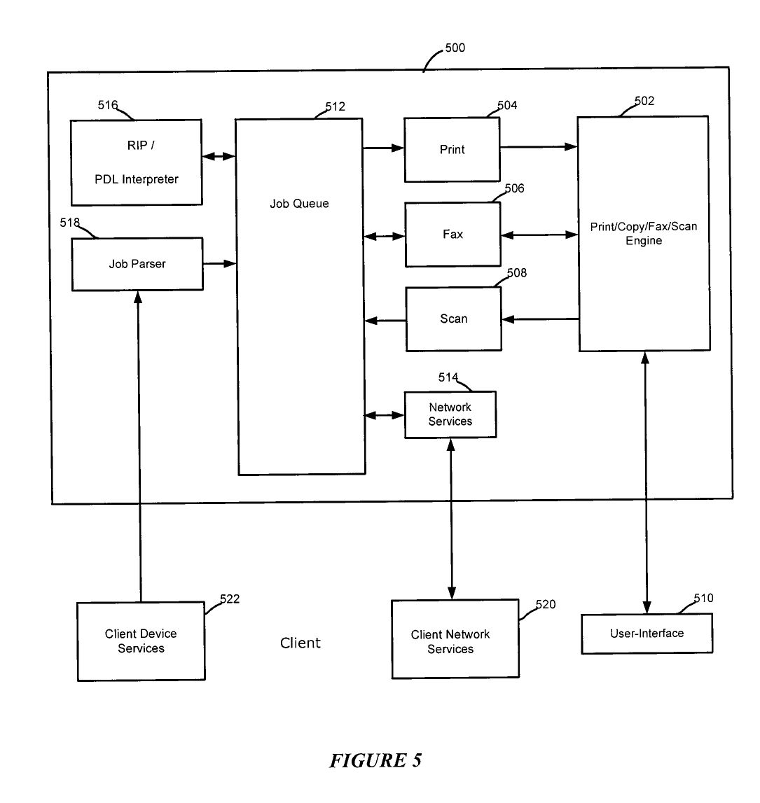

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for scheduled distribution of updated documents of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, event data, invitee data, scheduling data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

FIG. 1 also includes a server 118 in data communication with the computer network 102 via a communications link 122. In accordance with one embodiment of the subject application, the server 118 includes a data storage device 120 coupled thereto. As will be appreciated by those skilled in the art that the data storage device 120 is capable of storing a electronic document data, user identification data, document processing configuration data, account data, address data, and the like. The communications link 122, as will be understood by those skilled in the art, is any suitable channel of data communications known in the art including, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The Parser 518 functions to interpret a received electronic document file and relay it to the job queue 512 for handling in connection with the afore-described functionality and components.

In operation, document data representing at least one electronic document associated with a meeting event, identification data representing each of a plurality of invitees to the meeting event, and event data corresponding to the scheduled timing of the meeting event is stored in the associated data storage. Document processing operation data, representing at least one document processing operation, is also stored in the associated data storage. The stored document data is then retrieved from the data storage in accordance with the stored event data. At least one document processing operation is then commenced on the retrieved document data according to the stored document processing operation data.

In accordance with one example embodiment of the subject application, a document processing device 104 receives a document processing request from an associated user 124. It will be appreciated by those skilled in the art that such a request is capable of originating from the user device 114, via the computer network 102, via direct interaction at the user interface 106, or the like. According to one embodiment of the subject application, the document processing request includes one or more electronic documents and one or more corresponding document processing operations to be performed on respective electronic documents. The skilled artisan will appreciate that the document processing request of the subject application is capable of including data corresponding to the location or identification of one or more electronic documents, such that the document processing device 104 retrieves such electronic documents from a remote storage, e.g., the data storage device 120 associated with the server 118, the user device 114, or the like.

The controller 108 or other suitable component associated with the document processing device 104 then receives event schedule data. Preferably, the event schedule data corresponds to a scheduled timing of the meeting event, e.g., a time and date, when the meeting is to occur. Invitee data is then received from the associated user 124 corresponding to the attendees of the meeting event or the recipients of the document processing request. The skilled artisan will appreciate that such invitee data includes at least a number of invitees, thus indicating the number of documents to be output. In accordance with one embodiment of the subject application, the invitee data is capable of including, for example and without limitation, electronic mail address data, facsimile data, name, address, contact information, and the like. Thus, the skilled artisan will appreciate that the invitee data is capable of including a plurality of varying identification components so as to generate an appropriate number of output documents, output transmissions, output messages, and the like.

When the document processing request received from the associated user 124 includes document identification information, the controller 108, or other suitable component associated with the document processing device 104, retrieves the electronic documents from locations designated by the document identification information for further processing. Upon receipt of document data, event data, and invitee data, the controller 108 or other suitable component of the document processing device 104, then calculates the amount of time required to perform all document processing operations associated with the received document processing request. Thus, for example and without limitation, the controller 108 determines the processing time of any printing, copying, facsimile, conversion, or other document processing operations based upon invitee data. It will be appreciated by those skilled in the art that he user 124 is capable of specifying preselected timing whereupon the document processing request is to be completed by the document processing device 104. That is, the user 124 specifies a predetermined point in time when the document processing device 104 is to have completed processing the electronic documents associated with the document processing request. The electronic documents are then stored in the data storage device 110 by the controller 108 for later output.

The controller 108 then, based upon the event data and the amount of processing time, generates an output schedule representing when the document processing device 104 is to begin and finish outputting the electronic documents according to the received document processing request. The skilled artisan will appreciate that the generation of the output schedule is further capable of being based upon a preselected output time received from the user 124. In accordance with one embodiment of the subject application, the controller 108 then directs, via the user interface 106 associated with the document processing device 104, or via the user device 114, the display of the generated output schedule to the associated user 124.

In accordance with one embodiment of the subject application, the controller 108 then monitors the event data to determine whether the associated user 124 has modified the event data, e.g., changed the date or time of the meeting event or the preselected time at which the user 124 requires the document processing operation be completed. When the event data is determined to have been modified, the controller 108 recalculates the output schedule in accordance with the modified event data. Any updates to the output schedule are thereafter displayed to the user 124. The skilled artisan will appreciate that such display to the user 124 of the output schedule is capable of being accomplished via graphical representations via the user interface 106, the user device 114, via electronic mail communication to the user 124, via SMS text messaging to the user 124, or any suitable combination thereof. When the controller 108 determines that no modifications to the event data have been detected, the controller 108 analyzes the documents associated with the received document processing request to determine whether any of the electronic documents have been modified. When one or more documents have been modified, the modified electronic document is retrieved, e.g., from the user device 114, from the data storage device 120, or the like. Thereafter, the controller 108 calculates the time required to perform the requested document processing operations based upon the modified electronic document or documents. The modified documents are then stored in the data storage device 110 associated with the document processing device 104.

When none of the documents have been detected as having been modified, the controller 108 analyzes the schedule data to determine whether the document processing device 104 should begin performing the requested document processing operations. That is, the controller 108 determines whether the schedule data, e.g., date/time, etc., indicates that the document processing device 104 should begin processing the document processing request at the present time. When no such determination is made, the controller 108 thereafter continues monitoring event data and document data for modifications. This monitoring continues until such time indicated by the schedule data for the commencement of outputting the electronic documents.

When the controller 108 determines that it is time to commence outputting the electronic documents, the controller 108 directs the retrieval of the documents from the data storage device 110. Thereafter, the controller 108 controls the document processing device 104 so as to facilitate the performance of each of the document processing operations associated with the received document processing request. The document processing device 104 then outputs the documents as requested in the document processing request. For example, the documents are capable of being printed, bound, and designated for each invitee, based upon the received invitee data, communicated via electronic mail message or facsimile to each invitee, or the like.

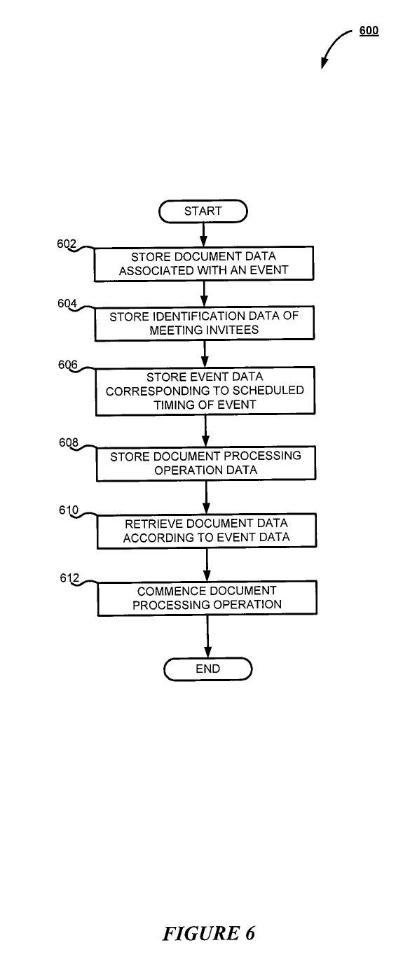

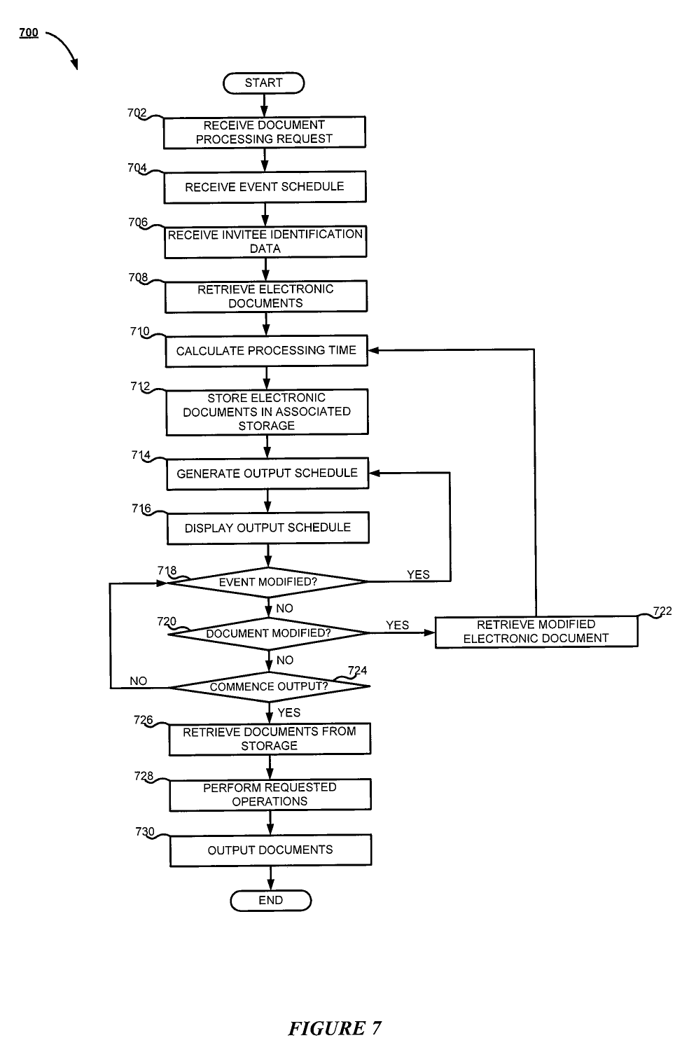

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for scheduled distribution of updated documents in accordance with one embodiment of the subject application. Beginning at step 602, document data representing at least one electronic document associated with a meeting event is stored in an associated data storage. For example, the controller 108 associated with the document processing device 104 directs the storage, in the data storage device 110, of one or more electronic documents corresponding to a meeting, event, presentation, or the like. At step 604, the controller 108 directs the storage of identification data corresponding to each of a plurality of invitees to the meeting event in the data storage device 110. That is, the document processing device 104 receives, from the associated user 124 via the user interface 106, the user device 114, or the like, identification data corresponding to each invitee to the meeting event. Suitable identification data includes, for example and without limitation, an electronic mail address, a name, a facsimile number, an identification number, a user name, or other identifying indicia. The skilled artisan will appreciate that the invitee data further enables the controller 108 to determine the number of invitees and thus the total number of documents required to be output by the document processing device 104.

Event data representing a scheduled timing of the meeting event is then stored, at step 606, in the data storage device 110 associated with the document processing device 104. The skilled artisan will appreciate that suitable event data includes, for example and without limitation, a date, a time, a location, etc., corresponding to the associated meeting event. At step 608, the controller 108 directs the storage of document processing operation data in the data storage device 110 corresponding to at least one document processing operation to be performed by the document processing device 104 on the received electronic document data.

The controller 108, at step 610, then directs the retrieval of the document data according to the received event data. Stated another way, the controller 108 determines that the stored electronic documents are to be output based upon the scheduled timing of the event data and thereafter retrieves the electronic document data from the associated data storage device 110. The controller 108 then facilitates, at step 612, the commencement of the document processing operations associated with the document processing operation data on the retrieved electronic document data.

Referring now to FIG. 7, there is shown a flowchart 700 illustrating a method for scheduled distribution of updated documents in accordance with one embodiment of the subject application. The methodology depicted in FIG. 7 begins at step 702, whereupon a document processing device 104 receives, from an associated user 124, a document processing request inclusive of electronic document data and corresponding document processing operations. In accordance with one embodiment of the subject application, the document processing request is capable of originating remotely from the user device 114, directly via the user interface 106, or the like. The skilled artisan will appreciate that the document processing request received by the document processing device 104 is capable of including document information corresponding to location and identification of one or more documents for output by the document processing device 104, e.g., stored on the server 118, stored on the user device 114, or the like. It will also be understood by those skilled in the art that the document processing request received from the user 124 corresponds to one or more document processing operations and associated electronic documents that are associated with a meeting, presentation, event, or the like.

Event schedule data corresponding to the timing associated with the meeting event is then received at step 704. It will be understood by those skilled in the art that such event data is capable of being supplied by the user 124 via the user interface 106, the user device 114, or the like. Preferably, the event schedule data indicates the date and time at which the user 124 requires the document processing operations be completed, e.g., before the start of a conference, in time for a meeting, or the like. At step 706, the controller 108 or other suitable component associated with the document processing device 104 receives invitee identification data from the associated user 124. In accordance with one embodiment of the subject application, the invitee data includes, for example and without limitation, data corresponding to invitee names, electronic mail addresses, facsimile numbers, and the like.

The documents identified by the document processing request are then retrieved by the controller 108 at step 708 so as to determine, at step 710, the amount of time required by the document processing device 104 to perform the requested document processing operations thereon. The skilled artisan will appreciate that the subject application is capable of bypassing step 708, e.g., when the document data is included in the document processing request, or retrieving from remote or local storage, e.g., the data storage device 110, the data storage device 120, or the like, when step 708 is implemented.

Once the processing time has been calculated at step 710, flow proceeds to step 712, whereupon the controller 108 facilitates the storage of the electronic documents in an associated storage. In accordance with one embodiment of the subject application, the documents are stored in the data storage device 110 associated with the document processing device 104. It will be appreciated by those skilled in the art that the subject application is capable of implementation wherein the documents are stored remotely from the document processing device 104, e.g., in the server 118, and accessible by the document processing device 104 via the computer network 102.

Using the received event data and the calculated processing time, the controller 108 then generates, at step 714, an output schedule corresponding to when the document processing device 104 will begin and complete processing of the electronic documents in accordance with the received document processing request. At step 716, the controller 108 directs the user interface 106 to display the output schedule to the associated user 124. The skilled artisan will appreciate that the display of the schedule is also capable of being accomplished via communications to the user device 114 for display thereon.

The controller 108 then determines, at step 718, whether any modifications to the event data have been made by the user 124. That is, whether or not the date, time, location, or the like, as set forth in the event data, has been modified by the associated user 124. When such a modification is detected by the controller 108, flow returns to step 714, whereupon an output schedule is generated in accordance with the modified event data. The user 124 is then presented with a display of the modified output schedule at step 716 as set forth in greater detail above. When it is determined at step 718 that no modifications to the event data have been made, flow proceeds to step 720, whereupon the controller 108 verifies that no modifications have been made to any of the documents associated with the received document processing request. In the event that modifications to one or more documents have been detected, the modified electronic document or documents are retrieved by the controller 108 at step 722. Thereafter, flow returns to step 710 to allow the controller 108 to determine the amount of time necessary for the document processing device 104 to complete the requested document processing operations. The skilled artisan will appreciate that a modified electronic document may require a greater or lesser amount of processing time than that of its predecessor document.

When it is determined at step 720 that none of the electronic documents associated with the received document processing request have been modified, flow proceeds to step 724. At step 724, the controller 108 determines whether or not to commence processing of the document processing request. That is, the controller 108 determines whether or not to initiate the processing of the electronic documents so as to output the documents prior to predetermined point in time before the start of the meeting event associated with the document processing request. When the controller 108 determines that the time has not yet arrived to begin processing the electronic documents associated with the document processing request, flow returns to step 718, whereupon the controller 108 continues monitoring for changes to event data and document data.

When the controller 108 determines at step 724 that the time has arrived to initiate the document processing operations requested by the user 124, flow proceeds to step 726. At step 726, the controller 108 or other suitable component associated with the document processing device 104, retrieves the electronic documents corresponding to the received document processing request from the data storage device 110. The document processing device 104 then commences, at step 728, the performance of the one or more document processing operations on the electronic documents associated with the received document processing request. Thereafter, the electronic documents are output by the document processing device 104 at step 730. It will be appreciated by those skilled in the art that such output includes, for example and without limitation, printing, facsimile transmission, electronic mail transmission, copying, or the like.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for scheduled distribution of updated documents comprising:
a data storage including,
means adapted for storing document data representative of at least one electronic document associated with a meeting event,
means adapted for storing identification data representative of each of a plurality invitees to the meeting event,
means adapted for storing event data representative of a scheduled timing of the meeting event, and
means adapted for storing document processing operation data representative of at least one document processing operation;
retrieval means adapted for retrieving stored document data from the data storage in accordance with the event data; and
document processing means adapted for commencing at least one document processing operation on retrieved document data in accordance with the document processing operation data.

2. The system for scheduled distribution of updated documents of claim 1 wherein the at least one document processing operation is from a set comprising a print operation, electronic mail operation, and facsimile transmission.

3. The system for scheduled distribution of updated documents of claim 1 wherein the retrieval means includes means adapted for retrieving stored document data at a preselected timing prior to the meeting event.

4. The system for scheduled distribution of updated documents of claim 3 further comprising means adapted for receiving data representative of the preselected timing from an associated user.

5. The system for scheduled distribution of updated documents of claim 1 further comprising:
detection means adapted for detecting modification to stored electronic document data; and
wherein the document processing means includes means adapted for commencing at least one document processing operation on retrieved document data in accordance with an output of the detection means.

6. The system for scheduled distribution of updated documents of claim 1 further comprising means adapted for displaying data representative of a timing of the at least one document processing operation.

7. A method for scheduled distribution of updated documents comprising the steps of:
storing document data representative of at least one electronic document associated with a meeting event in an associated data storage;
storing identification data representative of each of a plurality of invitees to the meeting event in the associated data storage;
storing event data representative of a scheduled timing of the meeting event in the associated data storage;
storing document processing operation data representative of at least one document processing operation in the associated data storage;
retrieving stored document data from the associated data storage in accordance with the event data; and
commencing at least one document processing operation on retrieved document data in accordance with the document processing operation data.

8. The method for scheduled distribution of updated documents of claim 7 wherein the at least one document processing operation is from a set comprising a print operation, electronic mail operation, and facsimile transmission.

9. The method for scheduled distribution of updated documents of claim 7 wherein the stored document data is retrieved at a preselected timing prior to the meeting event.

10. The method for scheduled distribution of updated documents of claim 9 further comprising the step of receiving data representative of the preselected timing from an associated user.

11. The method for scheduled distribution of updated documents of claim 7 further comprising the step of detecting modification to stored electronic document data; and wherein the commencement of at least one document processing operation on retrieved document data is in accordance with an output of the step of detecting modification to the store electronic document data.

12. The method for scheduled distribution of updated documents of claim 7 further comprising the step of displaying data representative of a timing of the at least one document processing operation.

13. A computer-implemented method for scheduled distribution of updated documents comprising the steps of:
storing document data representative of at least one electronic document associated with a meeting event in an associated data storage;
storing identification data representative of each of a plurality of invitees to the meeting event in the associated data storage;
storing event data representative of a scheduled timing of the meeting event in the associated data storage;
storing document processing operation data representative of at least one document processing operation in the associated data storage;
retrieving stored document data from the associated data storage in accordance with the event data; and
commencing at least one document processing operation on retrieved document data in accordance with the document processing operation data.

14. The computer-implemented method for scheduled distribution of updated documents of claim 13 wherein the at least one document processing operation is from a set comprising a print operation, electronic mail operation, and facsimile transmission.

15. The computer-implemented method for scheduled distribution of updated documents of claim 13 wherein the stored document data is retrieved at a preselected timing prior to the meeting event.

16. The computer-implemented method for scheduled distribution of updated documents of claim 15 further comprising the step of receiving data representative of the preselected timing from an associated user.

17. The computer-implemented method for scheduled distribution of updated documents of claim 13 further comprising the step of detecting modification to stored electronic document data; and wherein the commencement of at least one document processing operation on retrieved document data is in accordance with an output of the step of detecting modification to the store electronic document data.

18. The computer-implemented method for scheduled distribution of updated documents of claim 13 further comprising the step of displaying data representative of a timing of the at least one document processing operation.
